(19) United States
(12) Patent Application Publication
(10) Pub. No.: US 2008/0106726 A1
(43) Pub. Date: May 8, 2008

(54) Currency detection & tracking system and method

(76) Inventor: Ellis Park, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/592,287

(22) Filed: Nov. 2, 2006

(51) Int. Cl. G07D 7/12; G06K 9/74

(52) U.S. Cl. 356/71; 194/302

(57) ABSTRACT

A counterfeit detector is adapted for determining the authenticity of a monetary instrument having a barcode printed thereon. The counterfeit detector comprises a barcode scanner configured to scan the barcode and extract data therefrom. The counterfeit detector is configured to determine the authenticity of the monetary instrument by comparing the barcode data to a database of information related to the monetary instrument. The counterfeit detector may further comprise a local or central terminal in real-time communication with the barcode scanner. The terminal has a local database installed thereon which contains the information related to monetary instruments. the local terminal is configured to compare the barcode data to the local database information to determine the authenticity of the monetary instrument.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally to counterfeit detection and, more particularly, to a system and method for authenticating documents such as monetary instruments. In addition, the present invention relates to a unique system for tracking the movement of monetary instruments such as paper currency as a tool for combating money laundering and other criminal activities.

Public and private organizations around the world are continually incorporating the latest counterfeit detection features into monetary instruments such as paper currency in an effort to combat the growing counterfeit problem made possible by increasingly sophisticated document reproduction techniques. Because counterfeiters now have the capability to not only reproduce visually accurate copies of legitimate paper currency, but even accurately reproducing the look and feel of the paper upon which the currency is printed, increasingly sophisticated techniques have been developed to facilitate detection of counterfeit paper currency.

For example, some paper currencies include ultraviolet (UV) sensitive markings which are virtually undetectable under normal lighting conditions. However, when placed underneath a UV light source, the UV-sensitive markings exhibit a glowing effect indicating the authenticity of the paper currency. Even further, certain entities, such as the U.S. government, have integrated additional features into UV-sensitive markings as a redundant check for the authenticity of the paper currency. More specifically, some UV-sensitive markings are specifically adapted to exhibit the glowing effect in a particular color which correlates to a given denomination of the paper currency. For example, the UV-sensitive markings in one-hundred dollar ($100 USD) bills are designed to emit a reddish glow when illuminated by a UV light source.

An additional method which has been employed to detect counterfeit documents includes watermarks which may be incorporated into paper currency and other monetary instruments and which are only visible under certain lighting condition. The watermark may be embedded into the substrate of the paper document and becomes visible when backlit by UV light. In addition, the specific type or design of the watermark may correlate to a specific denomination of paper currency as a cross-check of its authenticity. Some paper watermarks are designed in the likeness of the same political or historical figure whose portrait is plainly visible under normal lighting conditions.

Another prior art anti-counterfeit technique includes the use of magnetic detection technology in combination with magnetic ink printed on the paper substrate. Magnetic detectors are capable of detecting the magnetic ink that is used during printing of the paper currency. As an additional counterfeit detection measure, the magnetic ink may be used in only specific locations on the paper currency. With this technique, magnetic detectors can validate or authenticate paper currency if the magnetic ink is detected in the proper location.

The prior art includes additional counterfeit detection methods. One such popular counterfeit detector is a pen-shaped device that is popular with retail merchants. The pen-shaped device contains a solution consisting partly of iodine which chemically reacts with copy paper commonly used in electrostatic copy machines. As opposed to paper that is used for printing legitimate paper currency, electrostatic copier paper is typically a wood-based material that reacts with the iodine creating a black mark on counterfeit paper. However, when the pen-shaped device is used on genuine paper currency, no black mark is created.

Other anti-counterfeit methods have been used to thwart criminal counterfeiting activities. For example, some paper currency includes miniature lettering and other features on certain bills which are only visually detectable through the use of a magnifying glass. Some paper currency may also include a security strip that is embedded into the paper substrate and which is only visible when backlit by a high luminescence light source. Other paper currency may employ the use of color-shifting ink which causes a change in the tint or color of particular features. When tilted back-and-forth or up-and-down, the reflective characteristics of the color-shifting ink causes a change in the tint or color of the feature due to the changing angle at which light reflects off of the feature. Unfortunately, as counterfeiters become more sophisticated, the ability to detect counterfeit documents using the above-mentioned anti-counterfeit methods is becoming increasingly difficult.

Related to the above-described anti-counterfeiting efforts is the on-going battle against money-laundering schemes as used by organized crime and drug trafficking. Money-laundering schemes may also be used in the financing of terrorist activities around the world. Criminal money laundering comprises a series of transactions that typically involve a financial institution such as a bank. The money laundering process starts when proceeds from illegal activities are initially deposited into a bank and are then withdrawn or are converted into alternative instruments such as traveler's check, stocks or other instruments. Alternatively, a legitimate asset may be purchased with the proceeds. Later, the traveler's checks or stocks may be exchanged for cash or the asset sold and the initial value of the ill-gotten proceeds are ultimately provided back to the instigators of the criminal activity.

In an effort to thwart money-laundering activities, the Currency and Foreign Transactions Reporting Act (i.e., also known as the Bank Secrecy Act or BSA) was enacted by the U.S. government as an attempt to track the movement of funds implicated in money-laundering schemes. Under the BSA, banks and other financial institutions are required to comply with certain record-keeping requirements. For example, the BSA requires financial institutions to file a record of all transactions involving funds of greater than $10,000 including purchases of negotiable instruments. In addition, the BSA requires financial institutions to report suspicious transactions that might indicate money-laundering schemes or other criminal activities.

Furthermore, the BSA requires financial institutions to retain records of cash sales of certain monetary instruments such as traveler's checks within a predetermined range of value. Financial institutions that fail to file the required reports or keep logs or records of cash purchases within the predetermined ranges are subject to penalties including heavy fines and harsh restrictions that may, in extreme cases, include charter revocation. For small banks and financial institutions, the reporting and record keeping requirements mandated by the BSA impose a heavy burden making it difficult to remain competitive with larger and better-established institutions.

In consideration of the above-described problem associated with counterfeit detection and in consideration of the desire to combat money-laundering schemes, it can be seen that there exists a need in the art for an improved method for determining the authenticity of a monetary instrument such as currency bills and which is not dependent upon the integration of specific security features (i.e., watermarks, magnetic ink) for authenticating a document. Furthermore, it can be seen that there exists a need in the art for a document authenticating system which can be operated on an autonomous basis and which may be seamlessly integrated into conventional instrument handling equipment common to financial institutions such as currency counters typically used in banks.

In addition, there exists a need in the art for a system and method for automatically tracking and recording currency transactions in order to detect money laundering schemes. Such a tracking and recording system may provide a relatively low-cost and convenient means to comply with reporting requirements such as that which is mandated by the Bank Secrecy Act. Ideally, the tracking and recording system can be integrated with counterfeit detection. Furthermore, the counterfeiting detection system and the tracking and recording system are preferably integrated into a seamless network on a domestic and/or international scale in order to assist in the fight against money-laundering across international borders.

### BRIEF SUMMARY

The present invention specifically addresses and alleviates the above-reference deficiencies associated with counterfeit detectors of the prior art. More particularly, the present invention includes a counterfeit detector that is specifically adapted to determine the authenticity of a monetary instrument having a barcode printed thereon. In addition, the present invention comprises a means to track and record transactions in real-time on a server-accessible database in order to detect and suppress money-laundering and other criminal activities.

The counterfeit detector, in one embodiment, may comprise a barcode scanner which is specifically adapted to scan a barcode and extract data representative of the identity of the monetary instrument which bears the barcode. The counterfeit detector is also configured to determine the authenticity of the monetary instrument by comparing the barcode data extracted during scanning to a database of information related to the monetary instrument. The database of information may be installed on a local and/or central terminal which is in wireless and/or hardwired communication with the barcode scanner.

Wireless transmission technology by which the barcode scanner may communicate with the local terminal includes, but is not limited to, WiFi™, Bluetooth™, infrared, short wave, ultrasound, microwave, cellular, satellite, etc. Hardwired transmission technologies for facilitating communication between the local terminal and the barcode scanner include, but are not limited to, conventional conductive wiring, ethernet, fiber optic, Local Area Network (LAN), Wide Area Network (WAN) and/or any combination thereof.

In a further embodiment, the counterfeit detector may comprise a central database installed on a server. The server may be adapted to be placed in communication with the counterfeit detector wherein the database contains information related to the monetary instrument in the same manner discussed above with regard to the local terminal. Likewise, the central database includes the necessary processor and/or logic to allow comparison of the barcode data to information contained in the database relating to monetary instruments. In short, the database provides a means to cross-check the barcode data with known (i.e., preprogrammed) information relating to some of all monetary instruments. In this manner, the central database facilitates authentication of monetary instruments scanned by the barcode scanner.

In each of the above-described embodiments, the counterfeit detector is capable of real-time communication with the local terminal, central terminal, and/or server although it is contemplated that the counterfeit detector and the local/central terminal and/or server may communicate on a variety of timing schedules including on a delayed, periodic and/or manually-activated basis. The server is preferably placed in communication with the counterfeit detector through an internet network such that the server is accessible by at least one server portal by means of a personal computer (i.e., desktop PC), a laptop, a personal digital assistant (PDA), a cellular telephone, or any other means configured for accessing the server.

In a further embodiment, the current counterfeit detector may be integrated or installed in a currency counter of the type commonly used in financial institutions such as banks. The currency counter may include a housing having an input station and an output station. The barcode scanner may be disposed within the housing. The input station of the currency counter is adapted to accommodate a plurality or stack of currency bills. The barcode scanner is configured to scan the barcode of each currency bill in the stack during counting of the stack of bills as the currency bills move sequentially from the input station to the output station.

Likewise, the counterfeit detector may be additionally adapted to ascertain the denomination of each of the currency bills through a variety of technologies including optical character recognition (OCR) or other suitable imaging means. In a further embodiment, the counterfeit detector may additionally or alternatively comprise a remote transponder that is adapted to scan an radio frequency identification (RFID) element such as an RFID chip or thread that may be integrated into each monetary instrument. Using RFID technology, the remote transponder is adapted to transmit an interrogation signal or scanner signal from the remote transponder during counting of each of the currency bills.

Alternatively, the remote transponder may be used as a standalone device independent of the currency counter or any other handling equipment. Contained with the scanner signal is a telemetry data request which is received at the RFID element which causes the RFID element to, in turn, wirelessly transmit a data signal containing information representative of the document being counted and scanned. The data signal is received back at the remote transponder which then extracts information regarding the document. The information contained in the data signal is compared to a database of information installed at a local and/or central database or terminal in the same manner as was described above. The remote transponder is also adapted to be placed in communication with a local terminal through a variety of means such as hardwired and/or wireless communication and may include accessible via an internet network.

The present invention further comprises a method of preparing a document such as a monetary instrument for allowing later detection of its authenticity. Such method comprises the steps of printing a barcode and/or installing an RFID element in the document. The barcode includes symbologies that are representative of identification data that may also be installed in the database installed locally (i.e., on a local terminal) or centrally (i.e., on a central database). Alternatively, the barcode itself may include data such as a set of numbers that correlate to a serial number that may be imprinted on the currency.

The method of preparing the document may further comprise the step of imprinting of the barcode in combination with a variety of other conventionally known counterfeit detection features such as watermarks, magnetic ink, ultraviolet-detectable features mentioned above. Documents that may be prepared for use with the counterfeit detector described above include paper currency, cashier's checks, traveler's checks, money orders, postal orders, stocks, bonds and any other instrument wherein it is desirable to authenticate and track the movement thereof.

### BRIEF DESCRIPTION OF THE DRAWINGS

These and other features and advantages of the various embodiments disclosed herein are better understood with respect to the following description and drawings in which like numbers refer to like parts throughout and in which:

FIG. 1 is a schematic diagram of a counterfeit detector comprising a barcode scanner in wireless and/or hardwired communication with a database installed on a local terminal or central database and which may be accessible by a server via a server portal;

FIG. 2 is an illustration of a U.S. currency bill having a barcode imprinted thereon and which is readable by the barcode scanner (i.e., counterfeit detector) as may integrated into a currency counter shown in FIG. 1; and

FIG. 3 is an schematic illustration of the various components that make up the counterfeit detector and which may be placed in wireless and/or hardwired communication with a local or central terminal which may include a server-mounted database.

### DETAILED DESCRIPTION

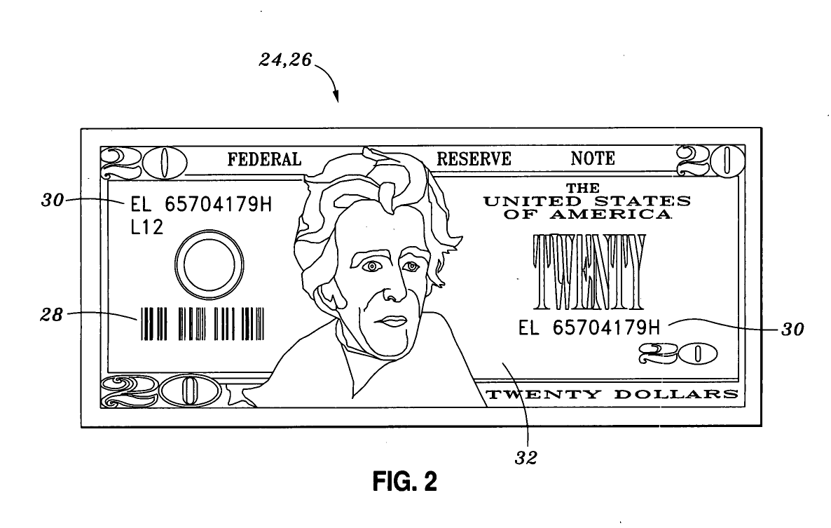

Referring now to the drawings wherein the showings are for purposes of illustrating preferred embodiments of the present invention and not for purposes of limiting the same, shown is a counterfeit detector 10 which may be adapted for determining the authenticity of a document including monetary instruments 24 such as a currency bill 26. As can be seen in FIG. 2, a barcode 28 may be printed on at least one or both sides of any document such as the currency bill 26 shown in FIG. 2. As is known in the art, barcodes 28 are machine-readable symbols comprised of a series of parallel bars of variable width and spacing which are scannable by an optical or laser scanner.

The barcode 28 imprinted on the currency bill 26 shown on FIG. 2 preferably has a reduced size in comparison to barcodes 28 utilized in retail or warehouse environments. In retail environments, Universal Product Code (UPC) barcodes are typically scanned at a cash register at a point-of-sale (POS) establishment and are used to identify and track inventory as well as indicate the selling price of a particular product. Other barcodes are used for inventory purposes such as in a warehouse environment. The barcode scanner 12 of the present invention may be used in the above-mentioned establishments and is further adapted for use in financial institutions such as banks and credit unions in a manner described in greater detail below.

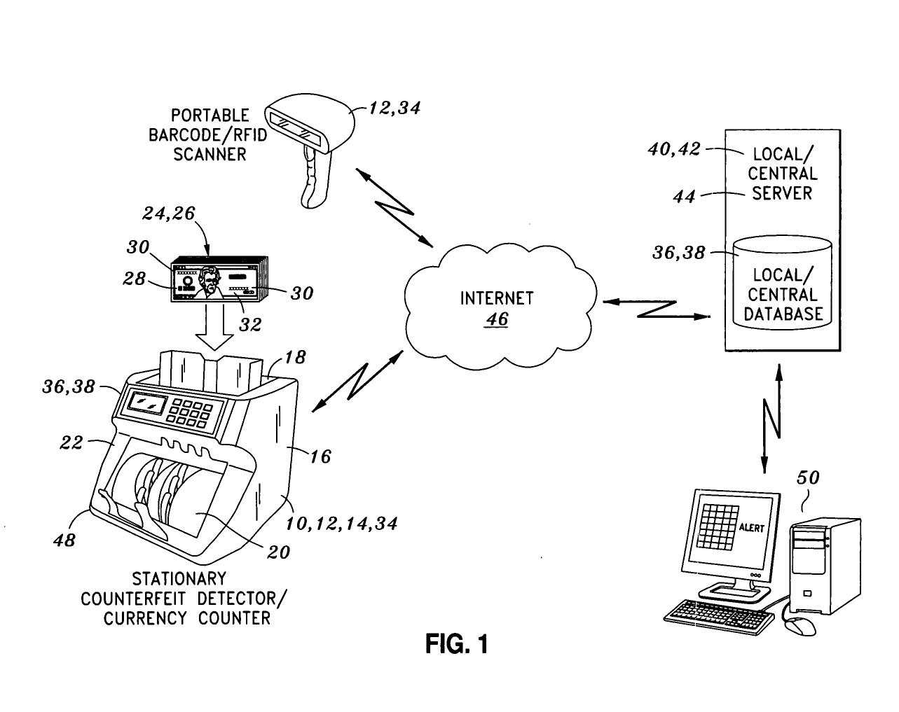

Referring still to FIG. 1, the barcode scanner 12 is shown optionally integrated into a stationary counterfeit detector 10 or the barcode scanner 12 may be provided as a standalone countertop device such as the currency counter 14 shown in FIG. 1. Alternatively, the barcode scanner 12 may be provided as a hand-held device as also shown in FIG. 1. The barcode scanner 12 is configured to scan the barcode 28 on a document and extract data from the barcode 28. The barcode scanner 12 is adapted to interpret the varying widths of the vertical bars and auto-discriminate the barcode 28 based upon the pattern of the vertical bars at the beginning and end of the barcode 28. The authenticity of the document such as a currency bill 26 may be verified with the counterfeit detector 10 by comparing data extracted from the barcode 28 as read by the barcode scanner 12 to a database of information related to various documents such as monetary instruments 24.

More specifically, the counterfeit detector 10 utilizes the barcode 28 to cross-check the barcode 28 data with various types of information contained within the database which may include, but is not limited to, the type of the document, denomination (for currency), date of printing, and location of printing. For currency bills 26, the location of printing may correlate to the specific mint that produced the currency bill 26. As may be appreciated, a wide variety of types of information may be encoded in the barcode and later utilized to cross-check with a database in order to verify the authenticity of the document.

Importantly, the counterfeit detector 10 of the present invention is adapted for integration into equipment commonly used in financial institutions. As mentioned above, the counterfeit detector 10 may be integrated into the currency counter 14 as used by many banks as well as in other locations where cash transactions occur such as casinos, bars, nightclubs and restaurants. As is well known in the art, currency counters 14 are adapted for quickly counting large sums of cash. As can be seen in FIG. 1, shown is a currency counter 14 which may include the counterfeit detector 10 integrated therewith. The currency counter 14 may include a housing 16 having an input station 18 and an output station 20. The barcode scanner 12 may be disposed or integrated within the housing 16.

The currency counter 14 is adapted to receive a quantity of currency bills 26 in the input station 18 and count the quantity thereof as the currency bills 26 move sequentially from the input station 18 to the output station 20. Simultaneously, the barcode scanner 12 may be adapted to scan the barcode 28 imprinted in each of the currency bills 26 during the counting process. In this manner, the currency counter 14 can efficiently and quickly detect counterfeit cash and/or other forged documents during the counting process.

Conventional counterfeit detection means may further be included within the counterfeit detector 10/currency counter 14 of the present invention as a backup or cross-check with the barcode scanner 12 in order to assess the authenticity of monetary instruments 24. For example, the currency counter 14 may include ultraviolet lighting, fluorescent lighting for watermark detection, as well as magnetic detection hardware in order to detect the presence of conventional features that may also be built into the monetary instrument 24.

Importantly, the counterfeit detector 10 of the present invention may be adapted to operate in real-time mode wherein the barcode scanner 12 transmits the just-scanned barcode 28 data to a local and/or central terminal 40 containing a database of information in order to determine the authenticity of the monetary instrument 24. More specifically, the counterfeit detector 10 may include the local terminal 36 which is in communication with the barcode scanner 12 and which contains a local database 38 containing information related to monetary instruments 24 such as paper currency bills 26. The local terminal 36 may include the appropriate logic required to compare and cross-check barcode 28 data to the local database 38 of information.

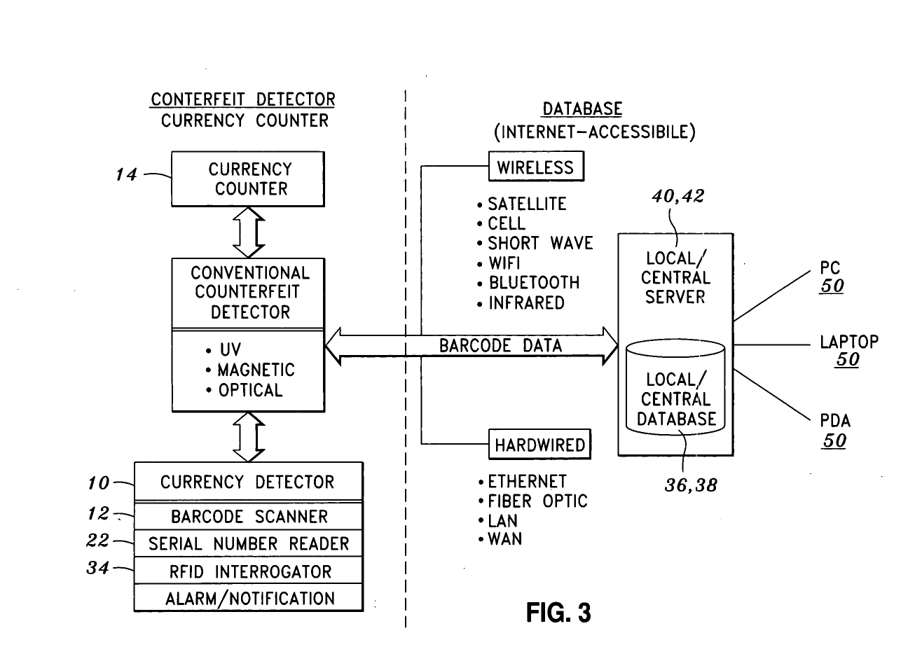

As can be seen in FIG. 1, the local terminal 36 may be in either wireless and/or hardwired communication with the barcode scanner 12 in order to allow such real-time cross-checking of the barcode 28 data. In wireless mode, the barcode scanner 12 may utilize various transmission technologies including, but not limited to, WiFi™, Bluetooth™, infrared, shortwave, ultrasound, and microwave technologies. In addition, as shown in FIG. 3, wireless communication between the counterfeit detector 10 and the database on the local and/or central terminal 36, 40 may be facilitated through the use of cellular telephone and satellite transmission technology. Additionally, communication between the counterfeit detector 10 and the local and/or central database 38, 42 may be by any suitable hardwired means including ethernet, fiber optic, Local Area Network (LAN), and/or Wide Area Network (WAN), or any combination thereof.

It is contemplated that the local database 38 may be individually loaded on a stand-alone counterfeit detector 10 unit that may be installed in financial institutions as well as in other locations such as in retail establishments. In this regard, the individually loaded database information may comprise data that is specific to the type of monetary instruments 24 and/or other documents which that specific location handles. Therefore, any change in type of document and identity thereof may be periodically loaded into the database information.

In a further embodiment, information related to monetary instruments 24 may be contained on a central database 42 which may be installed on a server 44 adapted to be in communication with the counterfeit detector 10 by any suitable wireless and/or hardwired means. As in the local database 38 scenario, the central database 42 may also be configured to compare barcode 28 data extracted from the barcode scanner 12 to the database information in determining the authenticity of the documents. Although communication between the counterfeit detector 10 and the database may be on a delayed, periodic or manually-activated basis, the counterfeit detector 10 is preferably in real-time communication with the server 44. In this manner, an immediate alert may be provided to a financial institution or merchant upon the detection of fraudulent currency in order to avoid losses to the merchant.

The present invention presents a distinct advantage over conventional counterfeit detection equipment utilized by merchants such as the above-mentioned pen detector device which is time-consuming and inconvenient to customers and merchants. Because of the advantages provided by automatic cross-checking of the barcode 28 data with the database information, merchants may no longer be limited to a policy of accepting only bills of small denomination. Therefore, the present invention greatly increases convenience for both customers and merchants alike to the same extent afforded by credit card monitoring systems.

As is well know, modern credit card processing technology allows for real-time cross-checking of fraudulent or stolen cards as well as allowing real-time detection of insufficient credit limits. Even more importantly, the present invention provides an advantage over conventional counterfeit detection which typically occurs only after the transaction has occurred and which is typically too late to catch the individual passing the fraudulent currency. Because of the real-time determination of the authenticity of a paper currency, police or other law enforcement maybe notified of any suspected criminal activity.

Referring to FIGS. 1 and 3, real-time communication between the server 44 and the counterfeit detector 10 may be effectuated through the use of an internet network 46 wherein a server 44 which has the database installed thereon is accessible through at least one server portal 50. In this regard, anywhere there is internet access, authorized individuals may log-on to the server 44 such as through a secured connection for access to the database. Access to the database allows for the review of records of cash transactions wherein the identity of individual currency bills 26 may be included in the database. The database may also allow for earmarking of any currency bills 26 which have been detected or suspected of being counterfeit or which may be suspected of being stolen.

Referring briefly to FIG. 2, the counterfeit detector 10 may optionally or alternatively be adapted to scan or read serial numbers 30 which may be printed on various monetary instruments 24 such as paper currency. As such, the counterfeit detector 10 may include a serial number reader 22 in a currency counter 14 such that reading of the serial number 30 may occur contemporaneous with the counting of a stack of the currency. The counterfeit detector 10 may be adapted to cross-match barcode 28 data extracted from the barcode scanner 12 with the serial number 30 as scanned by the serial number reader 22 as a further check on the authenticity of the currency bill 26. Such serial number 30 information can be included in the database of information installed on the local terminal 36 and/or central terminal 40.

Including the serial number reader 22 in addition to the barcode scanner 12 would also allow for detection of fraudulent instruments in the case of currency bills 26 wherein the barcode 28 data cannot be read due to damage to the currency bill 26. For example, the barcode 28 data may be overwritten by random handwritten notes or markings making it difficult or impossible for the barcode scanner 12 to accurately scan the barcode 28. In addition, the actual paper substrate itself may include holes or tears or may be otherwise damaged in the location wherein the barcode 28 data is printed. Therefore, the serial number reader 22 may serve as a redundant mechanism by which the authenticity of monetary instruments 24 may be verified if the barcode 28 is not readable.

An even further mechanism for determining the authenticity of paper currency may be provided by including optical character recognition (OCR) technology in the counterfeit detector 10. When activated, the OCR hardware may be adapted to scan each paper currency such as during counting in order to read various types of data commonly imprinted on monetary instruments 24. For example, the OCR hardware may be adapted to read the specific denomination of the paper currency which is usually printed in the corner location of U.S. currency bills 26. The denomination of the currency bill 26 as scanned by the OCR hardware may then be cross-checked with the barcode 28 data and/or the serial number 30 of each paper currency as a further cross-check on the authenticity of the document.

In another embodiment, the counterfeit detector 10 may optionally comprise or include radio frequency identification (RFID) technology as a means to detect counterfeit instruments. The counterfeit detector 10 may therefore include a remote transponder 34 which is adapted to detect an RFID element 32 such as an RFID chip, micro-chip or flexible thread which may be integrated into the document. Operating in a system similar to that shown in FIG. 1 and described above, the remote transponder 34 may be wirelessly and/or hardwired connected to a database installed on a local and/or central terminal 36, 40. The remote transponder 34 may wirelessly transmit a scanner signal when placed within receiving range of the document containing the RFID element 32. The scanner signal itself may contain a telemetry data request. The RFID element 32 may be either battery-powered or, more preferably, is passively powered (i.e., no batteries required) wherein power to operate the RFID element 32 is extracted from the scanner signal.

Upon receiving the telemetry data request, the RFID element 32 is powered up from its sleep state and transmits a data signal back to the remote transponder 34. The data signal may contain an identification code which correlates to the identity of the RFID element 32 and, hence, can be correlated to the identity of document as such information may be programmed in a database during the installation (e.g., during embedding) of the RFID element 32 into the document. The remote transponder 34 receives the data signal from the RFID element 32 and extracts the identification code contained within the data signal. The identification data is then compared to the database containing document identity information to determine the authenticity of the document in a manner similar to that described above for the barcode scanner 12 embodiment.

As discussed above, the remote transponder 34 may be provided in a hand-held device similar to that which is shown in FIG. 1 and which may be easily and conveniently used at a point-of-sale terminal to verify the authenticity of paper currency, especially large denomination bills (e.g., $100 USD). Alternatively, the remote transponder 34 may be integrated into a stationary terminal such as the currency counter 14 shown in FIG. 1. In addition, the remote transponder 34 may be integrated in combination with any of the above-described counterfeit detection methodologies, including, but not limited to the barcode scanner 12, the serial number 30 detector and any other conventional counterfeit detection means as known in the art. Regardless of whether the remote transponder 34 is a hand-held or stand-alone device or whether it is integrated into a stationary piece of equipment such as the currency counter 14, the remote transponder 34 is adapted to be placed in communication with a local and/or central terminal 40 which may be connected through an internet network 46 to the server 44 in a manner described above.

In this regard, the data signal from the remote transponder 34 may be transmitted from a local terminal 36 to the server 44 through the internet network 46 such that identification data extracted from the RFID element 32 may be correlated to document identity information installed at the server 44. As described above with regard to the barcode scanner, such data may be accessible through a variety of server portal 50 devices which may include a desktop PC, a personal digital assistant (PDA) such as a Palm Pilot™, a cellular telephone or any other suitable device. Data that may be correlated to the particular identification code contained within the data signal from the RFID element 32 may include information regarding the history of the document such as date and location of printing, denomination (for currency), serial number 30, and other types of information.

In a further aspect of the invention, the local and/or central database 38, 42 with which the barcode scanner 12 or serial number reader 22 accesses may further be regularly updated to provide a history of each incidence of scanning for a particular document. In this regard, the barcode scanner 12 provides a method of tracking the movement of various documents such as currency bills 26 which may be a tool useful for fulfilling Bank Secrecy Act (BSA) notification and recording requirements. As was mentioned above, the BSA requirement are imposed upon financial institutions and are intended in part to provide system for notifying regulatory authorities of cash transactions that exceed a certain aggregate amount in order to allow tracking of suspicious transactions. For example, the counterfeit detector 10 may be utilized to provide a record of cash transactions exceeding a predetermined amount (i.e., $10,000 monthly aggregate amount) as a means for tracking activity that might signify money-laundering and tax evasion.

By continually updating the database with regard to scanning of the barcode 28 imprinted on documents such as currency bills, a living history may be provided and may include information such as date of printing, history of each transaction and other pertinent information such as particulars regarding the identity of the person submitting the currency that was scanned. The information may also include the location and name of each financial institution where the document was scanned and recorded, the bank teller station, time/date information, and the total value of currency involved in the transaction with a particular currency bill 26.

Such updated recordings may be provided to the database for each currency or document that is suspected of being involved in money laundering or suspected as being counterfeit. The transaction recording may also include the capability to activate an automatic alarm or send a notification signal to law enforcement personnel in the event a counterfeit bill is detected. In addition, an alarm may be activated and/or notification may be sent if money-laundering is suspected or if the currency is indicated in the database as having involvement in prior criminal activity (e.g., indicated as being stolen).

The continuously updated history of currency bills 26 may be implementable at local and/or central databases 38, 42 and may further extend across international borders. In addition, the database records may be accessible by inter-governmental organizations such as the G7, the Financial Aid Task Force on Money Laundering (FATF), the International Monetary Fund (IMF) and other institutions such as the World Bank Group. Such a tracking system may allow private and public entities to track the origin of currency suspected in money laundering schemes or other fraudulent activities and take corrective measures. For example, upon notification by a financial institution that a particular transaction is suspected of involving money-laundering, authorities may access the database to determine the particular identity of individuals involved and the identity of the suspected currency bills 26 such that the bills can be frozen or removed from circulation. Furthermore, the tracking and recording system as described above may allow private organizations to track movement of currency from institution to institution.

The recording and notification system feature of the present invention is preferably implemented in a cost-effective, seamless and automated manner to allow smaller financial institutions to fully comply with BSA transaction recording and notification requirements. Furthermore, by the various embodiments of the present invention, national overseeing organizations such as the Federal Reserve Board may be better able to track usage and movement of monetary instruments 24 suspected to be involved in criminal activities and may further allow penetration into black market operations.

In a further embodiment, it is contemplated that the counterfeit detector 10 may be implemented in a mail sorter 48 such as may be used by the postal service of various governments. The mail sorter 48 may include any number of counterfeit detection means discussed above such as the barcode scanner 12, remote transponder 34 for scanning RFID elements 32 (i.e., chips) or the serial number reader 22. The mail sorter 48 may be adapted to track the movement of mail and record the history of such movements to a central database 42 containing address information. The mail sorter 48 may include the barcode scanner 12 which is adapted to scan a barcode 28 printed on mail documents and access a database installed on a local and/or central terminal 36, 40 or server 44 in order to allow the surveillance of future movements of certain mail document suspected to be involved in fraudulent or criminal activity.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A counterfeit detector for determining the authenticity of a monetary instrument having a barcode printed thereon, the counterfeit detector comprising:
a barcode scanner configured to scan the barcode and extract data therefrom;
the counterfeit detector being configured to determine the authenticity of the monetary instrument by comparing the barcode data to a database of information related to the monetary instrument.

2. The counterfeit detector of claim 1 further comprising:
a local terminal in communication with the barcode scanner and having a local database containing the information related to monetary instruments;
wherein the local terminal is configured to compare the barcode data to the local database information to determine the authenticity of the monetary instrument.

3. The counterfeit detector of claim 1 wherein the local terminal is in wireless communication with the barcode scanner using at least one of the following transmission technologies: WiFi™, Bluetooth™, infrared, shortwave, ultrasound, microwave.

4. The counterfeit detector of claim 1 further comprising:
a central database installed on a server that is adapted to communicate with the counterfeit detector, the database containing information related to the monetary instrument;
wherein the central database is configured to compare barcode data to the database information to determine the authenticity of the monetary instrument.

5. The counterfeit detector of claim 4 wherein the counterfeit detector is in real-time communication with the server.

6. The counterfeit detector of claim 4 wherein:
the server is in communication with the counterfeit detector through an internet network, the server being accessible through at least one server portal.

7. The counterfeit detector of claim 1 wherein:
the monetary instrument further includes a serial number;
the counterfeit detector further including a serial number reader configured to scan the serial number;
the counterfeit detector being configured to cross-check the barcode data with the serial number using the database information to determine the authenticity of the monetary instrument.

8. The counterfeit detector of claim 1 further comprising:
a currency counter including a housing having an input station and an output station;
wherein:
the barcode scanner is disposed within the housing;
the monetary instrument being comprised of a plurality of currency bills;
the input station being adapted to accommodate the currency bills;
the barcode scanner being configured to scan the barcode of each currency bill in the stack during counting by the currency counter as the currency bills move sequentially from the input station to the output station.

9. The counterfeit detector of claim 8 wherein the barcode is located in a predetermined area of each currency bill.

10. The counterfeit detector of claim 8 wherein the counterfeit detector is adapted to determine the denomination of each of the currency bills.

11. The counterfeit detector of claim 1 wherein the monetary instrument is provided in at least one of the following forms: paper currency, cashier's check, traveler's check, money order, postal order, stock, bond.

12. A method of authenticating a document having a barcode printed thereon, the method comprising the steps of:
scanning the barcode and extracting data therefrom; and
correlating the barcode data to a database of information related to the identity of the document.

13. The method of claim 12 wherein the document is a monetary instrument.

14. The method of claim 12 wherein the document further includes a serial number, the counterfeit detector further including a serial number reader configured to scan the serial number, the method further comprising the step of:
cross-checking the serial number with the barcode data using the database information to determine the authenticity of the document.

15. The method of claim 12 wherein the document is a currency bill having a denomination, the method further comprising the step of:
determining whether the barcode data matches the denomination or the serial number of the document using the database information.

16. A method of authenticating a document having an radio frequency identification (RFID) element included therewith, the method comprising the steps of:
providing a remote transponder;
wirelessly transmitting a scanner signal from the remote transponder, the scanner signal containing a telemetry data request;
receiving the scanner signal at the RFID element;
wirelessly transmitting a data signal at the RFID element in response to the telemetry data request;
receiving the data signal at the remote transponder and extracting document data therefrom; and
determining the authenticity of the document by comparison of the document data to a database containing document identity information.

17. The method of claim 16 wherein the RFID element is configured as an RFID chip integrated into the document.

18. The method of claim 16 wherein the remote transponder is adapted to be in communication with a local terminal connected through an internet network to a server having the database installed thereon, the method further comprising the steps of:
transmitting the data signal from the local terminal to the server through the internet network; and
comparing the document data to the document identity information in the database.

19. A method of tracking the movement of currency bills each having a barcode printed thereon, the method comprising the steps of:
scanning the barcode and extracting data therefrom;
transmitting the barcode data to a database; and
continuously recording in the database the barcode data and information relating to circumstances of the barcode scanning.

20. The method of claim 19 wherein:
the circumstances of the barcode scanning including total monetary value of scanned currency bills and time, date and location of scanning;
the barcode data corresponding to information contained in the database relating to the identity of each of the scanned currency bills.
